(19) United States
(12) Patent Application Publication
(10) Pub. No.: US 2022/0091311 A1
(43) Pub. Date: Mar. 24, 2022

(54) SAFE AND UNBREAKABLE PET FILM MIRRORS AND PREPARATION METHODS THEREOF

(71) Applicant: SHANGHAI BRISAFE TECHNOLOGY CO., LTD., Shanghai (CN)

(72) Inventor: Robert LEE, Shanghai (CN)

(21) Appl. No.: 17/417,907

(22) PCT Filed: Feb. 25, 2020
(86) PCT No.: PCT/CN2020/076520

§ 371 Date: Jun. 24, 2021

(30) Foreign Application Priority Data
Jun. 10, 2019 (CN) 201910494645.8

(51) Int. Cl. G02B 5/08; G02B 1/14; G02B 1/04; B29D 11/00; B29C 65/48

(52) U.S. Cl. CPC G02B 5/0866; G02B 1/14; G02B 1/04; B29K 2067/003; B29D 11/00865; B29C 65/48; B29D 11/00596

(57) ABSTRACT

The present application provides a safe and unbreakable PET film mirror and a preparation method thereof. The PET film mirror includes: a PET mirror surface; an aluminum alloy mirror frame disposed beneath the PET mirror surface; and an adhesive layer coated on a surface of the aluminum alloy mirror frame in contact with the PET mirror surface. The PET mirror surface includes: a PET-based film layer; a metal electroplated layer and an anti-oxidation coating, sequentially disposed on a back surface of the PET-based film layer; and a scratch-resistant resin layer disposed on a front surface of the PET-based film layer. The mirror according to the present application is light in weight, unbroken and highly safe. Even if damaged, it will not cause personal injury. In addition, the preparation method according to the present application has a simple process, occupies a small area, consumes few energy, and causes no pollution and damage to the environment.

### TECHNICAL FIELD

This application relates to a safe and unbreakable PET film mirror and a preparation method thereof.

### BACKGROUND

A mirror is an object with a smooth surface and an ability to reflect light. It is classified into two types: a plane mirror and a curved mirror. The most commonly used mirror is the plane mirror, which is mainly used for grooming, decorating, reflecting light, etc., and is widely used in many fields such as home, office, commerce and industry. It is one of the essential objects in daily life.

Currently, mirrors are mainly made of glass. However, the glass mirror is relatively heavy and inconvenient to transport and install. The glass mirror is also fragile and easy to fall and injure people and broken pieces of the glass mirror may scratch, cut or puncture people, causing personal injury. In addition, the production of glass mirrors consumes a lot of mineral resources and energy, occupies a large area, and causes serious pollution and great damage to the ecological environment.

In addition, some film mirrors are currently commercially available. Among others, one type is a relatively thick PC (polycarbonate) film mirror. A relatively great tensile force is needed to flatten the PC film mirror and then adhere it. But when the tensile force is relatively great, the resilience is also relatively great. After a period of time, the tension of mirror surface will decrease and the mirror imaging will be distorted. Another type is a relatively thin VMPET (vacuum metalized PET) film mirror, but its thermal shrinkage rate is higher than 20%, and its thermal shrink temperature is 70-100° C. The high thermal shrinkage rate and the low thermal shrink temperature can easily result in wrinkles on mirror surface due to a sharp change of ambient temperature, which affects the imaging effect.

PET is the abbreviation of polyethylene terephthalate, mainly including polyethylene terephthalate (PET) and polybutylene terephthalate (PBT). PET film is also known as high temperature resistant polyester film. It has excellent physical properties, chemical properties, dimensional stability, transparency and recyclability and can be widely used in magnetic recording, photosensitive materials, electronics, electrical insulation, industrial films, packaging and decoration, screen protection, optical surface protection and other fields. The PET film is a packaging material with multiple properties in a wide range. It has good transparency, gloss, air tightness and fragrance retention. The PET film owns excellent mechanical properties. Its strength and toughness are the highest of all thermoplastics. Its tensile strength and impact strength are much higher than that of ordinary films. It has appropriate stiffness and stable dimensions, and is suitable for secondary processing of printing, bag making and so on. The PET film also has outstanding heat resistance, cold resistance, chemical resistance and oil resistance.

### SUMMARY

In view of the above-mentioned technical problems existing in the prior art, this application proposes a safe and unbreakable PET film mirror, to provide a new mirror preparation material and method to avoid the unsafe use and inconvenient transportation and preparation of traditional mirrors.

In order to overcome the above technical problems, the present application adopts the following technical means:

A safe and unbreakable PET film mirror comprises: a PET mirror surface including a PET-based film layer, a metal electroplated layer and an anti-oxidation coating sequentially disposed on a back surface of the PET-based film layer, and a scratch-resistant resin layer disposed on a front surface of the PET-based film layer; an aluminum alloy mirror frame, disposed beneath the PET minor surface; and an adhesive layer, coated on a surface of the aluminum alloy mirror frame in contact with the PET mirror surface.

Optionally, the PET-based film layer is provided with a thickness of 10-100 microns, a light transmittance of greater than 90%, a haze of less than 1.5%, a shrinkage rate of less than 3%, and a definition of greater than 95%.

Optionally, the metal electroplated layer has a thickness of 500-1000 angstroms.

Optionally, the metal electroplated layer includes aluminum, silver, chromium or zinc.

This application further provides a preparation method of the safe and unbreakable PET film mirror, including:

(1) preparing a PET mirror surface: preparing a metal electroplated layer on a back surface of a PET-based film layer under vacuum, spraying an anti-oxidation coating on the metal electroplated layer, and spraying a synthetic resin on a front surface of the PET-based film layer to prepare a scratch-resistant resin layer;

(2) preparing an aluminum alloy mirror frame: preparing the aluminum alloy mirror frame according to a shape and a size of a desired mirror with a surface of each edge where the aluminum alloy mirror frame is in contact with the PET mirror surface being flat, smooth and free of burrs ensured:

(3) stretching the film: cutting the PET mirror surface to scale according to a size of the aluminum alloy minor frame, stretching the cut PET mirror surface around using mechanical equipment with a stretching tension controlled to 2-10N, and after stretching the cut PET mirror surface to be plane, adhering the stretched PET mirror surface to each edge of the aluminum alloy mirror frame where the aluminum alloy mirror frame is in contact with the PET mirror surface with a high-strength adhesive.

Optionally, the high-strength adhesive is a strong double-sided adhesive with a tensile strength greater than 14N/cm².

Optionally, in the step (3), when adhering the PET mirror surface, an operating temperature is 15-35° C., a positioning time is 20-30 minutes, and a curing time is 24-36 hours.

Optionally, in the step (3), the PET mirror surface covers and extends beyond a front surface of the aluminum alloy mirror frame, and is adhered to a side or a back surface of the aluminum alloy mirror frame with the high-strength adhesive.

With the above-mentioned technical means, the mirror according to the present application is light in weight, unbroken and highly safe. Even if damaged, the mirror will not cause personal injury. In addition; the preparation method according to the present application has a simple process, occupies a small area, consumes few energy, and causes no pollution and damage to the environment.

### BRIEF DESCRIPTION OF THE DRAWINGS

FIG. 1 is a schematic diagram illustrating a structure of a PET mirror surface according to the present application;

FIG. 2 is a schematic diagram illustrating a structure of a mirror according to the present application.

### DETAILED DESCRIPTION OF THE EMBODIMENTS

The technical solutions of the present application are further described below in detail by way of examples and in conjunction with drawings.

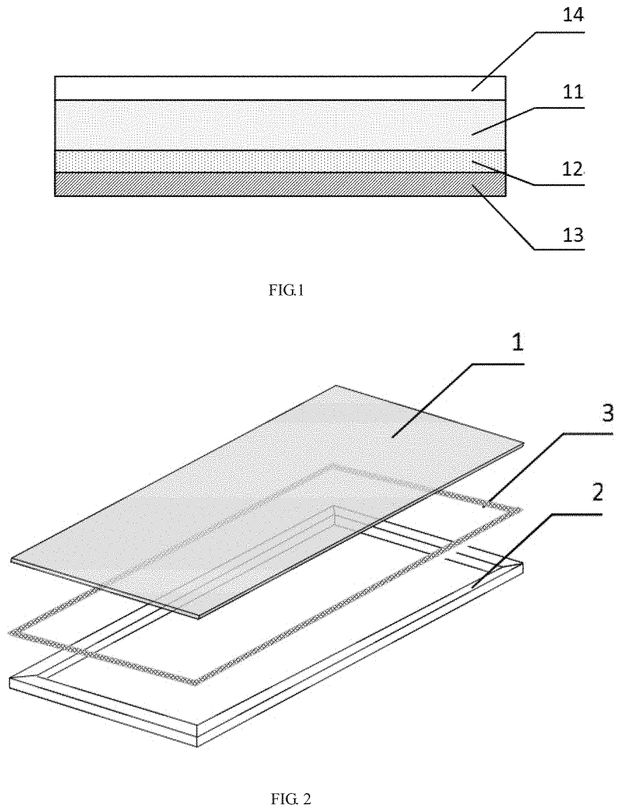

As shown in FIG. 2, a safe and unbreakable PET film mirror according to the present application includes a PET mirror surface 1, an aluminum alloy mirror frame 2 and an adhesive layer 3. As shown in FIG. 1, the PET mirror surface 1 includes: a PET-based film layer 11; a metal electroplated layer 12 and an anti-oxidation coating 13 sequentially disposed on a back surface of the PET-based film layer 11; and a scratch-resistant resin layer 14 disposed on a front surface of the PET-based film layer 11. The aluminum alloy mirror frame 2 is disposed beneath the PET mirror surface 1, and the adhesive layer 3 is coated on a surface of the aluminum alloy mirror frame 2 in contact with the PET mirror surface 1.

In order to achieve better specular light reflectivity, the PET-based film layer 11 with a thickness of 10-100 microns, a light transmittance of greater than 90%, a haze of less than 1.5%, a shrinkage of less than 3%, and a definition of greater than 95% is selected to be electroplated with metal. In the electroplating process, a thickness of the metal electroplated layer is controlled to be 500-10(X) angstroms. The metal electroplated layer is made of aluminum, silver, chromium or zinc.

In this example, an aluminum alloy profile is cut into 4 sections, including two sections as lengths of the frame and two sections as widths of the frame, according to a size of a desired aluminum alloy mirror frame 2. Two ends of each section of the aluminum alloy profile are beveled at a 45° angle. The four sections of the aluminum alloy profile are assembled to obtain the aluminum alloy mirror frame.

The aluminum alloy mirror frame 2 is not limited to the structure given in this example, and may be of other structures, such as a triangle, a polygon, a circle or an ellipse.

This application differs from the traditional mode of mirrors with glass as a material. A vacuum electroplated PET film with high light-reflectivity is used as a mirror surface, and a light aluminum alloy material is used to prepare a mirror frame, so that the weight of the PET film mirror is reduced to about 15% of an ordinary glass mirror with a same size. Therefore, the defect that the glass mirror is easily cracked when it is tilted, dropped or hit is avoided, and it is easy to transport the PET film mirror without taking additional safety protection measures. More importantly, the safety of the PET film mirror is high. Even if damaged, it will not cause personal injury. In addition, due to the characteristics of the PET material, the PET mirror surface according to the present application will maintain surface tension after preparation, be durable and resistant to high temperature, and not appear to be distorted.

This application further provides a preparation method of the safe and unbreakable PET film mirror, which includes the following steps:

(1) Preparing a PET mirror surface: aluminum, silver, chromium or zinc is melted and evaporated at a high temperature under high vacuum, so that metal vapor is deposited on a surface of a PET-based film layer to form a metal electroplated layer, which endows the PET-based film layer with a mirror effect with a high light-reflectivity. Then, an anti-oxidation coating made of a composite material with strong adhesion is sprayed on the metal electroplated layer to isolate air, protect the metal layer from blackening due to oxidation, and avoid corrosion caused by moisture, acid, alkali, etc. On an un-electroplated surface of the PET-based film layer, a transparent synthetic resin is sprayed to form a synthetic resin coating, which endows the PET mirror surface with scratch-resistance and friction-resistance, so that the light reflection effect of the PET mirror do not degrade due to daily wiping. With these operations, the processing for preparation of the PET mirror surface is completed.

(2) Preparing of an aluminum alloy mirror frame: the aluminum alloy mirror frame is prepared according to a shape and a size of a desired mirror. An aluminum alloy profile is cut into four sections, including two sections as lengths of the frame and two sections as widths of the frame. Two ends of each section of the aluminum alloy profile are beveled at a 45° angle. The four sections of the aluminum alloy profile are assembled to obtain an aluminum alloy frame. It is ensured that a surface of each edge of the aluminum alloy mirror frame which is in contact with the PET mirror surface is smooth and free of burrs. When the length or width of the aluminum alloy frame is greater than 50 cm, one or more aluminum alloy poles may be added to a middle position of the aluminum alloy mirror frame for fixing, so as to improve firmness and flatness of the aluminum alloy mirror frame.

In addition, in the step (2), aluminum alloy mirror frames, according to requirements, may be provided in another size and shape, such as a triangle, a polygon, a circle or an ellipse.

(3) Stretching the film: the PET mirror surface is cut to scale according to a size of the aluminum alloy mirror frame, and the cut PET mirror surface is stretched around using mechanical equipment with a stretching tension controlled to 2-10N. After the cut PET mirror surface is stretched to be plane, the stretched PET mirror surface is adhered to a surface of the edges of the aluminum alloy mirror frame with a high-strength adhesive. Adhering after stretching can make the PET film mirror surface smoother and the imaging reflection effect better. The light reflectivity of the stretched PET film mirror surface is 90%-95%, higher than the light reflectivity of ordinary glass mirrors, which is 90%. The high-strength adhesive may be a strong double-sided adhesive with a tensile strength greater than 14N/cm². When adhering the PET mirror surface, a best operating temperature is 15-35° C., a positioning time is 20-30 minutes, and a curing time is 24-36 hours. If the operating temperature is decreased, the positioning and curing time is extended accordingly.

In addition, in the step (3), the PET mirror surface covers and extends beyond a front surface of the aluminum alloy mirror frame, and is adhered to a side or a back surface of the aluminum alloy mirror frame with the high-strength adhesive. The frame of the finished mirror cannot be seen from the front, which makes the field of vision wider and the mirror more beautiful.

The safe and unbreakable PET film mirror according to the present application is unbreakable, light in weight, high in safety, convenient to carry and easy to use. Even if damaged, it will not cause personal injury. In addition, the PET film mirror prepared by the present application is acid-resistant, alkali-resistant, anti-oxidative, and not prone to occurrence of fogging, black spots due to oxidation, etc. at can be used in places with adverse environments such as bathrooms and chemical workshops. At the same time, the process for preparing a safe and unbreakable PET film mirror according to the present application is simple, covers a small area, consumes few energy, and causes no pollution and damage to the environment.

The above-mentioned embodiments are used only to illustrate the present application and not to limit the scope of the present application. Equivalent changes and modifications made to the present application by those skilled in the art shall fall within the scope of the appended claims of the present application.

1. A safe and unbreakable PET film mirror, comprising:
a PET mirror surface, comprising:
a PET-based film layer,
a metal electroplated layer and an anti-oxidation coating, sequentially disposed on a back surface of the PET-based film layer, and
a scratch-resistant resin layer, disposed on a front surface of the PET-based film layer;
an aluminum alloy mirror frame disposed beneath the PET mirror surface; and
an adhesive layer, coated on a surface of the aluminum alloy mirror frame in contact with the PET mirror surface.

2. The safe and unbreakable PET film mirror according to claim 1, wherein the PET-based film layer is provided with a thickness of 10-100 microns, a light transmittance of greater than 90%, a haze of less than 1.5%, a shrinkage rate of less than 3%, and a definition of greater than 95%.

3. The safe and unbreakable PET film mirror according to claim 1, wherein a thickness of the metal electroplated layer is 500-1000 angstroms.

4. The safe and unbreakable PET film mirror according to claim 1, wherein the metal electroplated layer comprises aluminum, silver, chromium or zinc.

5. A preparation method of the safe and unbreakable PET film mirror according to claim 1, comprising:
(1) preparing a PET mirror surface, comprising:
preparing a metal electroplated layer on a back surface of a PET-based film layer under vacuum,
spraying an anti-oxidation coating on the metal electroplated layer, and
spraying a synthetic resin on a front surface of the PET-based film layer to prepare a scratch-resistant resin layer;
(2) preparing an aluminum alloy mirror frame, comprising:
preparing, according to a shape and a size of a desired mirror, the aluminum alloy mirror frame with a surface of each edge where the aluminum alloy mirror frame is in contact with the PET mirror surface being flat, smooth and free of burrs ensured;
(3) stretching the PET mirror surface, comprising:
cutting the PET mirror surface to scale according to a size of the aluminum alloy mirror frame,
stretching the cut PET mirror surface around using mechanical equipment with a stretching tension of 2-10N, and
after stretching the cut PET mirror surface to be plane, adhering the stretched PET mirror surface to each edge of the aluminum alloy mirror frame where the aluminum alloy mirror frame is in contact with the PET mirror surface with a high-strength adhesive.

6. The preparation method according to claim 5, wherein the high-strength adhesive is a double-sided adhesive, with a tensile strength greater than 14N/cm².

7. The preparation method according to claim 5, wherein, in the step (3), when adhering the PET mirror surface, an operating temperature is 15-35° C., a positioning time is 20-30 minutes, and a curing time is 24-36 hours.

8. The preparation method according to claim 5, wherein, in the step (3), the PET mirror surface covers and extends beyond a front surface of the aluminum alloy mirror frame, and is adhered to a side or a back surface of the aluminum alloy mirror frame with the high-strength adhesive.
